(19) United States
(12) Patent Application Publication
(10) Pub. No.: US 2008/0252719 A1
(43) Pub. Date: Oct. 16, 2008

(54) APPARATUS, METHOD, AND SYSTEM FOR GENERATING STEREO-SCOPIC IMAGE FILE BASED ON MEDIA STANDARDS

(75) Inventors: Kwang-Cheol Choi, Gwacheon-si (KR); Jae-Yeon Song, Seoul (KR); Jung-Nyun Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/102,406

(22) Filed: Apr. 14, 2008

(30) Foreign Application Priority Data
Apr. 13, 2007 (KR) 36487/2007
Apr. 27, 2007 (KR) 41078/2007

(51) Int. Cl. H04N 13/00

(52) U.S. Cl. 348/43; 348/E13.001

(57) ABSTRACT

Provided is an apparatus, a method, and a system for generating a stereo-scopic image file based on media standards. The system includes a stereo-scopic image file generation apparatus for generating a stereo-scopic image file including a data area including a first video track including a first image data and a second video track including a second image data to be synchronized with the first image data for use in generating a stereo-scopic image, a header area including a first video track information area including information on the first video track and a second video track information area including information on the second video track; and an image reproduction device for, upon receiving input of the generated stereo-scopic image file, simultaneously decoding the first image data and the second image data into a stereo-scopic image and reproducing the decoded stereo-scopic image.

### PRIORITY

This application claims priority to application entitled “Apparatus, Method, And System For Generating Stereo-scopic Image File Based On Media Standards” filed with the Korean Intellectual Property Office on Apr. 13, 2007 and Apr. 27, 2007, and assigned Serial Nos. 2007-0036487 and 2007-0041078, respectively, the contents of which are incorporated herein by reference.

### BACKGROUND OF THE INVENTION

1. Field of the Invention

The present invention relates to an apparatus, a method, and a system for generating a stereo-scopic image file based on media standards, and more particularly to an apparatus, a method, and a system for generating a stereo-scopic image file compatible with a media file format based on a media standard, that is, an ISO (International Standards Organization) standard.

2. Description of the Related Art

Recently, in the field of imaging techniques, much research has been done on a method for implementing a stereo-scopic image, that is, a stereo-scopic image, rather than a two-dimensional image. Such a stereo-scopic image can represent more detailed and more realistic image information than a two-dimensional image. Now, credit in various aspects is focused on a possibility of a method in which a left-viewpoint image and a right-viewpoint image are scanned on corresponding positions of a conventional display device by utilization of human visual characteristics and then the left-viewpoint image and the right-viewpoint image are separately formed on the left eye and the right eye of a user so that the user can sense a stereo-scopic effect.

Such a stereo-scopic image is encoded after being separated into a left image and a right image due to the stereo-scopic image's characteristics, all image information is included in a stereo-scopic image file, and in a case of a general media file, one image information item is included in a stereo-scopic image file. A typical media player has no difficulties with reproducing a file including one image, such as a conventional general left image. However, to reproduce both left and right images included in a stereo-scopic image file, a Liquid Crystal Display (LCD) must support a stereo-scopic image, and a decoder must be designed for decoding a stereo-scopic image. Also, a file format must be designed for saving stereo-scopic information. In order to generate a stereo-scopic image as described above, a conventionally suggested method is to directly add one of left/right images on a data section of a stereo-scopic image, that is, on a user-information saving area of a video bit stream. The stereo-scopic image file generated by this method has an advantage in that synchronization is easily achieved because left/right images are sequentially decoded in a stereo-scopic image decoding process of a media player. However, there is a strong possibility that a decoder using an International Standards Organization (ISO) standard system may cause some problems because the file generated by the method is not in accordance with a media file format standard, that is, an ISO format file type. In addition, there is a possibility that a processing rate of a decoder may be significantly reduced because decoding must be processed, continuously detecting additional data by byte unit until the next header appears in a video bit stream.

In order to reproduce a stereo-scopic image file generated by the conventional stereo-scopic image file generation method as described above, both left/right images have to be reproduced. Therefore, a decoder and a player which can reproduce a stereo-scopic image, that is, the above two images, are additionally required.

As described above, since an additional decoder and an additional player are required so as to reproduce a stereo-scopic image generated by the conventional method in a mobile terminal, it is difficult to maintain compatibility in a conventional mobile terminal.

### SUMMARY OF THE INVENTION

Accordingly, the present invention has been made to solve the above-mentioned problems occurring in the prior art, the present invention provides an apparatus, method, and system for generating a stereo-scopic image file which is compatible with a media player using an International Standards Organization (ISO) based media file format.

Also, the present invention provides an apparatus, method, and system for generating a stereo-scopic image file which can be reproduced in a general media player.

According to an aspect of the present invention, there is provided a system for generating a media standard-based stereo-scopic image file and reproducing the generated stereo-scopic image file, the system including a stereo-scopic image file generation apparatus for generating a stereo-scopic image file including a data area and a header area, the data area including a first video track and a second video track, the first video track including a first image data, the second video track including a second image data to be synchronized with the first image data for use in generating a stereo-scopic image, the header area including a first video track information area and a second video track information area, the first video track information area including information on the first video track, the second video track information area including information on the second video track; and an image reproduction device for simultaneously decoding the first image data and the second image data into a stereo-scopic image and reproducing the decoded stereo-scopic image, upon receiving input of the generated stereo-scopic image file.

According to another aspect of the present invention, there is provided an apparatus for generating a media standard-based stereo-scopic image file, the apparatus including an encoder for encoding a first image data, and selectively encoding a second image data if encoding for the second image data is selected, the second image data being synchronized with the first image data for use in generating a stereo-scopic image; and a file generator for generating a stereo-scopic image file including a data area and a header area, the data area including a first video track and a second video track, the first video track including the encoded first image data, the second video track including the second image data encoded according to the selection, the header area including a first video track information area and a second video track information area, the first video track information area including information on the first video track, the second video track information area including information on the second video track.

According to another aspect of the present invention, there is provided a method of generating a media standard-based stereo-scopic image file, the method including receiving an input of a first image data and a second image data, the second image data being synchronized with the first image data for use in generating a stereo-scopic image; encoding the first image data, and encoding the second image data if encoding for the second image data is selected, the second image data being synchronized with the first image data for use in generating a stereo-scopic image; and generating a stereo-scopic image file including a data area and a header area, the data area including a first video track and a second video track, the first video track including the encoded first image data, the second video track including the second image data encoded according to the selection, the header area including a first video track information area and a second video track information area, the first video track information area including information on the first video track, the second video track information area including information on the second video track.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating a stereo-scopic image file generation apparatus for generating a stereo-scopic image file based on ISO according to an embodiment of the present invention;

FIG. 2 is a block diagram illustrating an image reproduction device for reproducing a stereo-scopic image file generated on the basis of ISO according to an embodiment of the present invention;

FIG. 3 is a block diagram specifically illustrating a file generator as shown in FIG. 1;

FIG. 4 illustrates a format of an ISO based stereo-scopic image file generated according to an embodiment of the present invention;

FIG. 5 illustrates a format of track information of a right video included in a stereo-scopic image file according to an embodiment of the present invention;

FIG. 6 is a flow diagram illustrating a process of generating a stereo-scopic image file based on ISO according to an embodiment of the present invention; and,

FIG. 7 is a flow diagram illustrating a reproduction process of a stereo-scopic image file generated according to an embodiment of the present invention.

FIG. 8 is a block diagram illustrating an ISO media file format according to an embodiment of the present invention.

### DETAILED DESCRIPTION OF THE EXEMPLARY EMBODIMENTS

Hereinafter, exemplary embodiments of the present invention will be described in detail with reference to the accompanying drawings. In the following description of the present invention, a detailed description of known functions and configurations incorporated herein is omitted to avoid making the subject matter of the present invention unclear.

The present invention provides a scheme of separately storing left/right images input by two cameras, generating a header in an ISO format when a header is generated for each image, and including the header in a stereo-scopic image file. Also, the present invention provides a scheme of adding a new right video track for including a right image in accordance with a media standard file format, that is, an ISO format, and thereby including the information of the right video track in accordance with a media standard in the header.

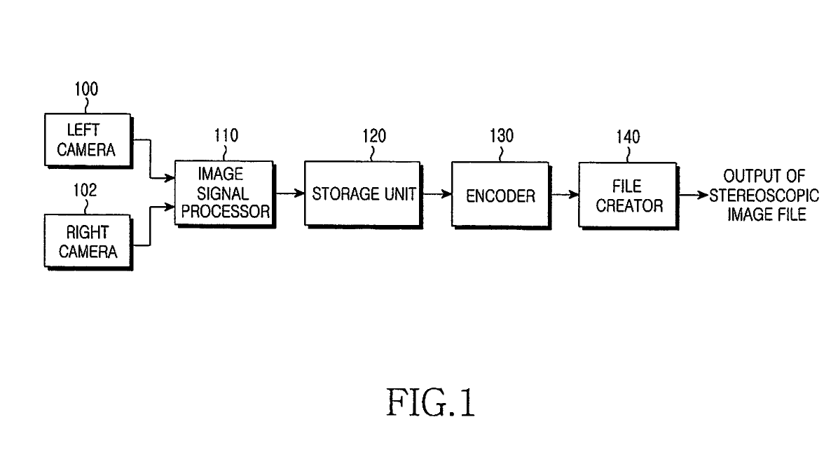

First, with reference to FIG. 1, the inner configuration and operation of a stereo-scopic image file generation apparatus for generating an ISO based stereo-scopic image file according to an embodiment of the present invention will be described. An apparatus for generating a stereo-scopic image file according to an embodiment of the present invention includes a left camera 100, a right camera 102, an image signal processor 110, a storage unit 120, an encoder 130, and a file generator 140.

In the apparatus according to the present invention, the left camera 100 and the right camera 102 function to photograph a stereo-scopic image. The left camera 100 photographs a left view image and outputs the photographed left image signal. Also, the right camera 102 photographs a right view image and outputs the photographed right image signal.

Once image signals output from the left camera 100 and the right camera 102 are input to the image signal processor 110, the image signal processor 110 performs a typical image preprocessing step, and outputs preprocessed image data. In the preprocessing step, an analog value, which is an external image value (such as the components of light and color) sensed by a Charge-Coupled Device/Complementary Metal-Oxide Semiconductor (CCD/CMOS) type sensor, is converted into a RAW image, which is a digital value.

The storage unit 120 stores left/right image data output from the image signal processor 110.

The encoder 130 encodes the left image data stored in the storage unit 120, and outputs the data. Also, the encoder 130 can compress the stored right image data or output the data as RAW data according to a user's selection. In addition, the encoder 130 can maintain the stored right image data in a different form according to a user's selection.

The file generator 140 generates a file header in accordance with a media standard, that is, an ISO format, for bit stream data, which is image data encoded by the encoder 130, and merges the encoded bit stream data and the generated file header into one file, thereby finally generating a stereo-scopic image file. In other words, the file generator 140 separates a left image and a right image, includes a bit stream for a right image in a new track, and generates a stereo-scopic image by combining a header including left video track information, audio track information and right video track information.

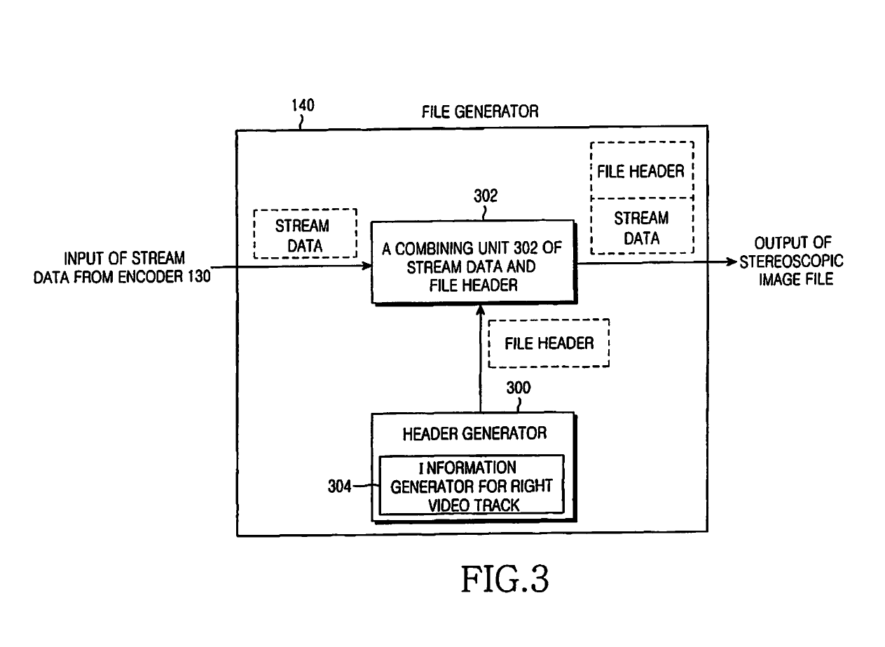

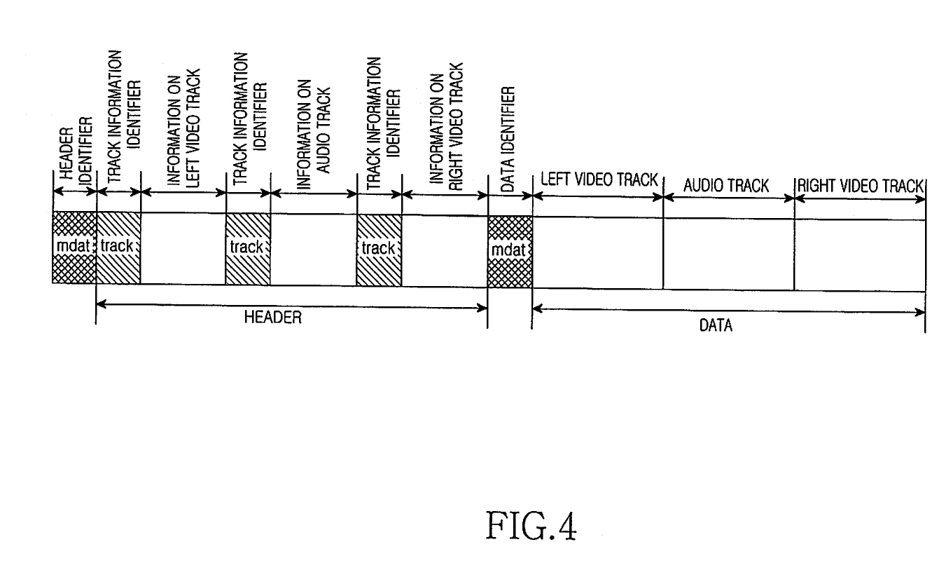

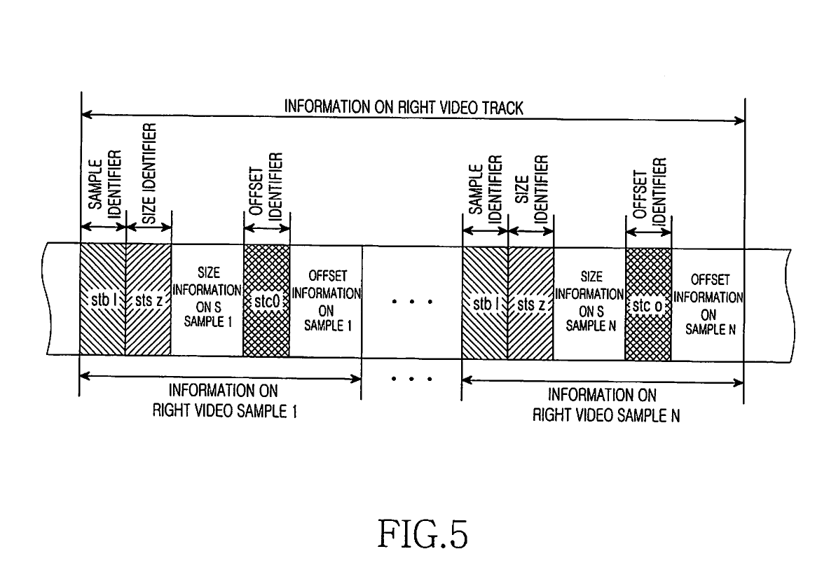

Hereinafter, a specific inner configuration of the file generator 140 according to an embodiment of the present invention will be described with reference to FIG. 3. Also, with reference to FIGS. 4 and 5, examples of an actually generated stereo-scopic image file will be described.

Generally, an ISO format file may include a plurality of tracks. While a configuration of a file necessarily requires one or more tracks, a general ISO format file includes a video track and an audio track. In the present invention, a new video track in an ISO format file is added to a right image. The added new track for a right image is shown as 400 with reference to FIG. 4. Also, header information for a right video track is shown as 402. When a new track is added in this manner, a header portion of an actual file has to be defined. Header information for a right video track will be described in detail with reference to FIG. 3.

Usually, a file in an ISO format, that is, a media standard file format for a mobile terminal, is divided into a header area representing metadata information of a file and a data area including actual bit stream data. Therefore, in header generation by the file generator 140 according to the present invention, header data is divided by using a 4-byte American Standard Code for Information Exchange (ASCII) value according to a pre-determined media standard, and a fixed offset of the divided ASCII value can represent data included in the division.

The ASCII value is largely divided as follows:

1. A header identifier, Movie Box (“moov”), and a data identifier Movie Data Box (“mdat”) are used as identifiers identifying a header and data, respectively;

2. A header includes an identifier, Track (“trak”), used to identify information of each track, such as left video track information, audio track information and right video track information; and

3. There is an identifier, Sample Table Box (“stbl”), for identifying each of sample information in the data within left video track information, audio track information and right video track information. For example, a sample in video track information may be a frame unit.

Next, a specific inner configuration and operation of the file generator 140 will be described with reference to FIG. 3, the file generator 140 generating an ISO format file by separating a right image encoded according to an encoded left image and options. The file generator 140 according to an embodiment of the present invention includes a combining unit 302 of stream data and a file header, and a header generator 300 provided with an information generator 304 for a right video track.

The header generator 300 inserts a header identifier in front of header information in order to identify a header area included in a stereo-scopic image file, and inserts a data identifier in front of data in order to identify a data area. The included identifiers may be represented as a 4-byte ASCII value.

The header identifier may be defined as “moov” as shown in FIG. 4, and the data identifier may be defined as “mdat.” As header information, information on a left video track, an audio track, and a right video track is included at the rear of “moov.” Also, a left video track, an audio track, and a right video track exist at the rear of “mdat”; a bit stream for a left image is included in a left video track; a bit stream for audio is included in an audio track; and a bit stream for a right image is included in a right video track.

The header generator 300 inserts “trak”, as an identifier for identifying an information area of a left video track, an information area of an audio track, and an information area of a right video track on a header area, in front of each track.

Also, the header generator 300 adds detailed information on samples included in a left video track to an information area of the left video track. The detailed information on samples included in the information area of the left video track may include information such as the number of frames forming a sample. In case of a format standard for an mp4 file, ‘stsd’ is detailed information on the actual samples and is described on a detailed description. Also, the header generator 300 adds information on an audio track to the information area of an audio track.

According to an embodiment of the present invention, the header generator 300 adds only offset information for representing a size and a position of each sample, on the information area of a right video track. Here, the header generator 300 inserts Sample Size Box (“stsz”) as an identifier for identifying information area of a sample size in front of the information area of a sample size, and inserts Chunk Offset Box (“stco”) as an identifier for representing a point where each sample is positioned in a file in front of the offset information area of each sample.

As described above, the present invention provides a method for generating a stereo-scopic image file in the form of an ISO format, that is, a media standard, by separating a right image which may be optionally encoded or unencoded according to an encoded left image and options. Also, the stereo-scopic image file generated in this manner can be fully compatible with a conventional mobile terminal without violating a file format standard, ISO/International Electrotechnical Commission (IEC) 14496-12.

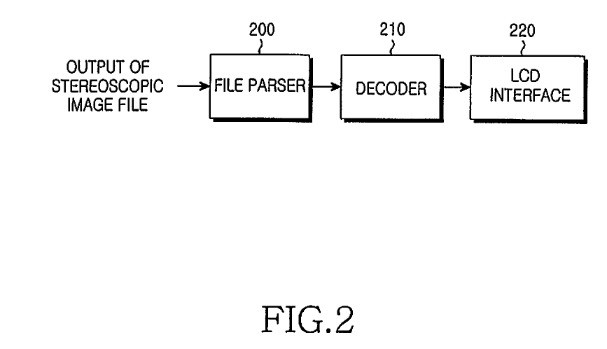

An inner configuration of an image reproduction device of FIG. 1 for receiving and reproducing an ISO-based stereo-scopic image file will be described with reference to FIG. 2. A reproduction device for a stereo-scopic image file generated according to an embodiment of the present invention includes a file parser 200, a decoder 210 and an LCD interface 220.

The file parser 200 parses the input stereo-scopic image file into header data and bit stream data.

The decoder 210 decodes encoded bit stream data with reference to header information included in header data parsed in the file parser 200. Therefore, when a left video track is reproduced so as to reproduce a stereo-scopic image, decoding/reproducing operations on an added right video track are possible simultaneously with bit stream data stored in the left video track by using only a position and a size, that is, information on a right video track. In other words, when a stereo-scopic image is reproduced, decoding is performed with reference to track information of a left video, in relation to synchronization of right/left video tracks and a reproduction starting point of a right image.

The LCD interface 220 may include a Liquid Crystal Display (LCD) and displays decoded bit stream data.

In reproduction of a stereo-scopic image file generated as shown in FIG. 4, a conventional media player ignores a newly added right video track because there is no analysis on the right video track, and reproduces the file by using conventional video/audio tracks. A system mounted with a decoder for added right image data provides a stereo-scopic image by additionally using right image data when a stereo-scopic image is reproduced.

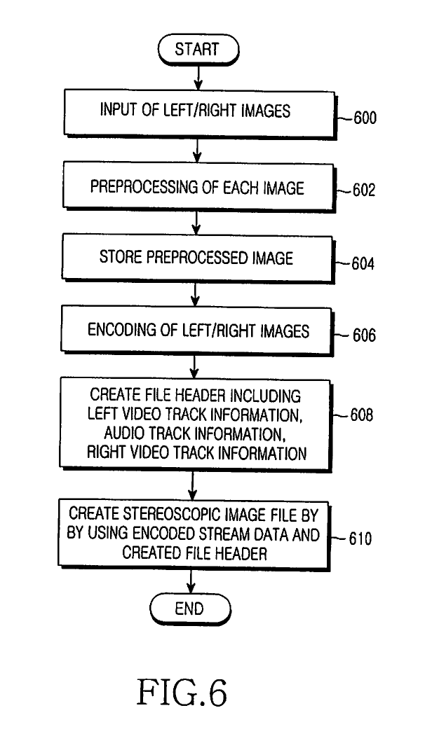

Hereinafter, a process of generating an ISO based stereo-scopic image file in a stereo-scopic image file generation apparatus configured as shown in FIG. 1 will be described with reference to FIG. 6.

In step 600, when left/right images are input to an image signal processor 110 through a left camera 100 and a right camera 102, the image signal processor 110 performs a preprocessing step for each image.

Then, the process proceeds to step 604, a storage unit 120 stores the image processed by the image signal processor 110.

In step 606, an encoder 130 encodes left/right images. Here, the encoder 130 can compress the stored right image data according to a user's selection and output the data as RAW data. Also, the encoder 130 can maintain the stored right image data in a different form according to a user's selection.

In step 608, a header generator 300 of a file generator 140 generates a file header including left video track information, audio track information and right video track information. The generated file header is shown as FIG. 5 and is described in detail with reference to FIGS. 1 and 3. Especially, in the present invention, an information area of a right video track includes size information on respective samples included in the right video track, and offset information from a data identifier to each sample.

In step 610, the file generator 140 merges bit stream data, that is, image data encoded by the encoder 130, and the file header generated in step 608 into one file, and then generates a stereo-scopic image file.

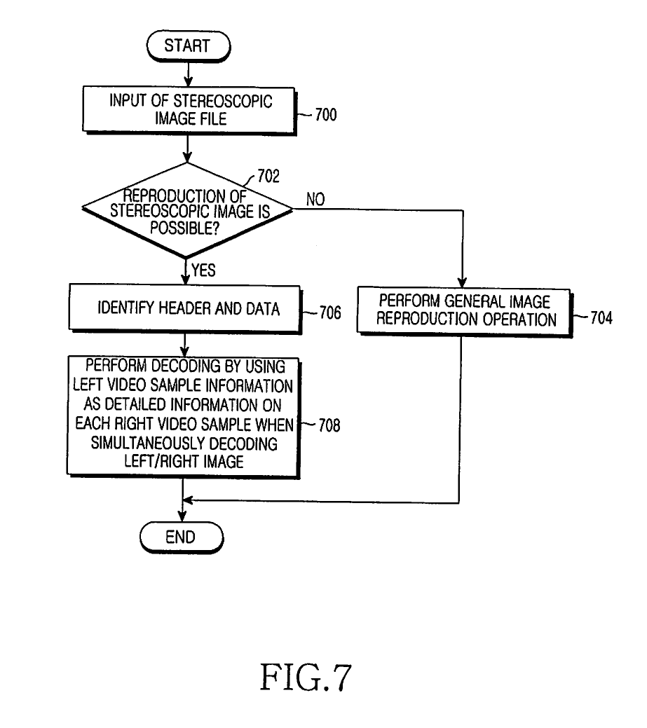

Then, in a reproduction device for a stereo-scopic image file as shown in FIG. 2, a reproduction process for a stereo-scopic image file generated by the method as shown in FIG. 6 will be described with reference to FIG. 7.

When, in step 700, a stereo-scopic image file is input, a file parser 200 determines whether a reproduction of the stereo-scopic image is possible in step 702, and if the stereo-scopic image reproduction is possible, the process proceeds to step 706 and identifies a header area and a data area.

In step 708, when left/right images are simultaneously decoded, a decoder 210 performs decoding by using left video sample information corresponding to detailed information of each right video sample. Through the decoding, right image data together with left image data can be used to provide a stereo-scopic image when a stereo-scopic image is reproduced.

In an embodiment of the present invention, it is assumed that left image data is basically included in an image file. However, according to a system operation, right image data may be basically included in an image file.

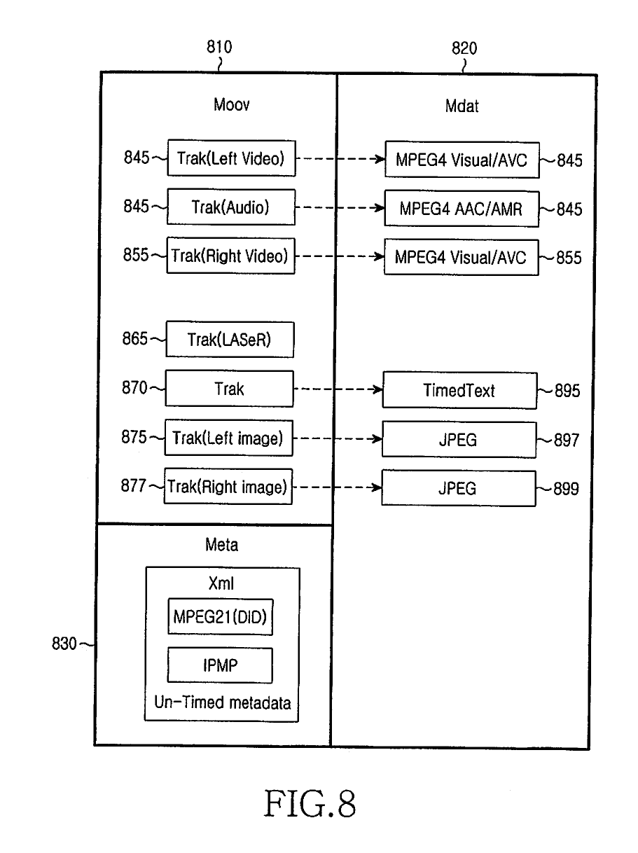

FIG. 8 is a block diagram illustrating an ISO media file format according to an embodiment of the present invention. In the above described embodiment, the term “area” is used to indicate each record for storing a variety of information, within a header area and a data area included in a stereo-scopic image file. For example, an area storing information on a video track is called a video track information area, and an area storing information on an audio track is called an audio track information area. However, in case of FIG. 8, since each record is shown as a box, hereinafter the term “box” will be used in order to easily describe the present invention with reference to FIG. 8. Therefore, it is obvious to persons skilled in the art that the term “box” to be used hereinafter has the same meaning as the term “area” used in the above described embodiment.

An ISO media file format is a standard by which information of a media file is defined, and fields and structures designated by the standard are used to define a file format suitable for a specific application. While FIG. 4 illustrates a file format, focusing on a section for stereo-scopic image effect, FIG. 8 illustrates the entire file format for the stereo-scopic image.

Referring to FIG. 8, as described above in the present invention, 810 is a header box (Moov) including header data, and 820 is a data box (Mdat) including substantial contents. Also, 830 is a Meta box within which an eXtensible Markup Language (XML) box is provided, and content protection information meta data and license information meta data related to the stereo-scopic image contents are recorded in the inner Xml box. In the inner XML box, untimed meta data, such as MPEG (Motion Picture Experts Group)-7 and TeleVision (TV) Anytime meta data, contains compressed video/audio contents. Such untimed meta data may be included within an MPEG-21 Digital Item Declaration (DID) of the Xml box in the Meta box, or may be included as a separate track within the Mdat box. Information on each of items indicating track boxes included in the MPEG-21 DID box within the Meta box can be mapped into iinfo/iloc information within the Meta box.

As a matter of course, the Meta data includes MPEG-7, MPEG-21, or TVAnytime data, etc.

Meta data for stereo-scopic image processing includes a variety of information, such as a distance between two cameras, whether a view is a cross-eye-view or a parallel-eye-view, a type of a camera, a ratio of a viewing distance to a use/validity depth, a number of used elementary streams (1 or 2), a process of mixing right/left images (that is, information on the used format, from among a Parallax Barrier format, a top-down format, a side-by-side format, a field sequential format, or a frame sequential format), a depth map, etc.

In order to synchronize with audio, video or image tracks, text data related to synchronization uses a synchronization file format in accordance with a file format, ISO/IEC 14496-17, as a synchronization text format. Also, in order to synchronize with a track, it is possible to employ a synchronization file format in accordance with a file format, ISO/IEC 14496-17, as a synchronization text format.

When data identified by each track is protected through encryption, content protection information meta data and license information meta data are recorded in the XML box within the Meta box by using Intellectual Property Management and Protection (IPMP), the content protection information meta data including encryption information, such as a tool used for the encryption, encrypted sections, and position information of key data for decoding the encryption, and the license information meta data including rights to use broadcasting contents, such as restrictions on a reproduction period, reproduction frequencies, and copy/modification/transfer of contents. Information on IPMP may be set within the header box (Moov) by using an IPMP descriptor, etc. Also, although not shown in FIG. 8, in case an IPMP control box, that is, an Intellectual Property Management Committee (IMPC) box, is used in the header box (Moov), the information on the IPMP may be expressed through an IPMP descriptor included in the ipmc box. Herein, IPMP data uses MPEG21 IPMP or Operation, Administration, and Maintenance (OAM) Digital Rights Management (DRM).

A box 845 is an information box including left video content information having left video contents, a box 850 is an information box including information on audio contents, and a box 855 is an information box including information on right video contents. Also, a box 865 is an MPEG4 Lightweight Application Scene Representation LASeRbox performing update and synchronization by displaying separate resources on one screen. Since a stereo-scopic image can be viewed to a user through downloading from a terminal and can be directly generated as a file by using a dual camera, in some cases, such as User Created Contents (UCC), etc., LASeR may not be used. In this case, information on the use of specific boxes defined according to a file format is defined as meta data of an ISO media file format.

On the other hand, a box 880 is a contents box including left video contents corresponding to the box 845. That is, as a video contents format, MPEG4 Visual Enhanced Simple Profile or MPEG4 Advanced Video Codec (AVC)/H.264 may be used. Also, a contents box 885 within the Mdat box, corresponding to the box 850, includes audio contents encoded as MPEG4 Advanced Audio Coding (AAC), Adaptive Multi-Rate (AMR), or AAC+. A contents box 890 within the Mdat box, corresponding to the box 855, uses MPEG4 Visual Enhanced Simple Profile or MPEG4 AVC/H.264, in which the same encoding is usually applied to a left video and a right video. A box 895 includes a TimedText to be synchronized specific contents, as contents corresponding to a box 870 within the Moov box. A box 897 includes a Joint Photographic Experts Group (JPEG) still image, as left still image contents corresponding to a box 875 within the Moov box. A box 899 includes a JPEG still image, as right still image contents corresponding to a box 877 within the Moov box.

Also, although not shown in FIG. 8, it is possible to mark a brand name of a standard applied to a stereo-scopic image by locating a File type and Compatibility (“ftyp”) box in front of the Moov box.

Track information suggested by the present invention, such as stsz, stco, etc, is not shown in FIG. 8 for convenience, but it is obvious that the entire information is assumed to be included within the track boxes 845, 850, 855, 865, 870, 875, and 877 as shown in FIG. 8.

Also, according to an ISO media file format, positions and configurations of a Moov box, an Mdat box, a Meta box. etc. may be changeable.

As described above, the present invention provides a method for generating a stereo-scopic image file in the form of an ISO format, that is, a media standard, and here, there is an advantage in that the generated image file can be fully compatible with a conventional mobile terminal without violating a file format standard, ISO/IEC 14496-12.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system for generating a media standard-based stereo-scopic image file and reproducing the generated stereo-scopic image file, the system comprising:
a stereo-scopic image file generation apparatus for generating a stereo-scopic image file comprising a data area and a header area, the data area comprising a first video track and a second video track, the first video track comprising a first image data, the second video track comprising a second image data to be synchronized with the first image data for use in generating a stereo-scopic image, the header area comprising a first video track information area and a second video track information area, the first video track information area comprising information on the first video track, the second video track information area comprising information on the second video track; and
an image reproduction device for, upon receiving an input of the generated stereo-scopic image file, simultaneously decoding the first image data and the second image data into a stereo-scopic image and reproducing the decoded stereo-scopic image.

2. The system as claimed in claim 1, wherein the information on the second video track comprises size information on a sample, the sample being included in the second image data included in the second video track, and offset information representing a distance from a predetermined reference point to each sample.

3. The system as claimed in claim 2, wherein the predetermined reference point is a starting point where the data area starts.

4. The system as claimed in claim 2, wherein the image reproduction device decodes the second image data by using the second video track information and the first video track information.

5. An apparatus for generating a media standard-based stereo-scopic image file, the apparatus comprising:
an encoder for encoding a first image data, and if encoding for a second image data is selected, selectively encoding the second image data, the second image data being synchronized with the first image data for a use in generating a stereo-scopic image; and
a file generator for generating a stereo-scopic image file comprising a data area and a header area, the data area comprising a first video track and a second video track, the first video track comprising the encoded first image data, the second video track comprising the second image data encoded according to the selection, the header area comprising a first video track information area and a second video track information area, the first video track information area comprising information on the first video track, the second video track information area comprising information on the second video track.

6. The apparatus as claimed in claim 5, wherein the information on the second video track comprises size information on a sample, the sample being included in the second image data included in the second video track, and offset information representing a distance from a predetermined reference point to each sample.

7. The apparatus as claimed in claim 6, wherein the predetermined reference point is a starting point where the data area starts.

8. A method of generating a media standard-based stereo-scopic image file, the method comprising the steps of:
receiving an input of a first image data and a second image data, the second image data being synchronized with the first image data for use in generating a stereo-scopic image;
encoding the first image data, and, if encoding for the second image data is selected, encoding the second image data, the second image data being synchronized with the first image data for use in generating a stereo-scopic image; and
generating a stereo-scopic image file comprising a data area and a header area, the data area comprising a first video track and a second video track, the first video track comprising the encoded first image data, the second video track comprising the second image data encoded according to the selection, the header area comprising a first video track information area and a second video track information area, the first video track information area comprising information on the first video track, the second video track information area comprising information on the second video track.

9. The method as claimed in claim 8, wherein the information on the second video track comprises size information on a sample, the sample being included in the second image data included in the second video track, and offset information representing a distance from a predetermined reference point to each sample.

10. The method as claimed in claim 9, wherein the predetermined reference point is a starting point where the data area starts.

11. An apparatus for generating a media standard-based stereo-scopic image file, the apparatus comprising:
a header area comprising a first information box in which information on right video contents is recorded, a second information box in which information on audio contents is recorded, and a third information box in which information on left video contents is recorded;
a data area comprising a first contents box, a second contents box, and a third contents box, the first, second, and third contents boxes corresponding to the first, second, and third information boxes, respectively, and comprising the right video contents, the audio contents, and the left video contents, respectively; and
a file generator for generating a stereo-scopic image file comprising a metadata area where encryption information related to the contents is recorded.
